(19) United States
(12) Patent Application Publication
(10) Pub. No.: US 2024/0108167 A1
(43) Pub. Date: Apr. 4, 2024

(54) Cooking Appliance With Dual User Interface

(71) Applicant: SEB S.A., Ecully (FR)

(72) Inventor: Jean-Philippe Robin, Ecully (FR)

(73) Assignee: SEB S.A., Ecully (FR)

(21) Appl. No.: 18/375,007

(22) Filed: Sep. 29, 2023

(30) Foreign Application Priority Data
Sep. 30, 2022 (FR) 2210019

(51) Int. Cl. A47J 36/32; A47J 37/06; A47J 37/07; F24C 15/14

(52) U.S. Cl. CPC A47J 36/32; A47J 37/0611; A47J 37/0709; A47J 37/0763; A47J 37/0786; F24C 15/14

(57) ABSTRACT

The cooking appliance includes a first structure having a first hotplate; a second structure having a second hotplate; a first user interface arranged on the first structure; a second user interface arranged on the second structure; a control unit configured to control the operation of the cooking appliance. The cooking appliance has a first mode of use, called grill mode, in which a food item is intended to be enclosed between the first and second hotplates, and a second mode of use, called barbecue mode, in which each of the first and second hotplates can hold and cook a respective food item. The first user interface is used for the first mode of use and the second user interface is used for the second mode of use.

### TECHNICAL FIELD

The present invention generally relates to a cooking appliance for cooking food products, and in particular to an electric cooking appliance such as a grill and/or barbecue.

### STATE OF THE ART

It is common in the prior art to use a cooking appliance that comprises:
a first structure comprising a first hotplate configured to cook a food item;
a second structure comprising a second hotplate, the second structure being hinged to the first structure around a pivot axis, and
a user interface that is provided on the first structure and that is configured to enable a user to select at least one operating parameter of the cooking appliance.

The cooking appliance as known in the prior art can alternatively have a “grill” feature in which a food item is intended to be enclosed and cooked between the first and second hotplates, and a second “barbecue” feature in which the first and second hotplates are spaced 180° apart so as to be substantially in the same plane, said plane being generally horizontal when the cooking appliance is resting on a horizontal surface.

The cooking appliance as described in the prior art advantageously enables a single household appliance to be used in two different ways: for grilling food and for barbecuing.

To improve the use and ergonomics of this family of cooking appliances, it is advantageous to provide a user interface that is easy and convenient for a user to access in all cooking modes, namely grill mode and barbecue mode. To this end, it is common practice to arrange the user interface on a front face of the first structure; however, such an arrangement of the user interface prevents the collection of cooking juices from a front panel of the first structure.

It is also common in the prior art to provide the user interface on the second structure of the cooking appliance, and more precisely on a handling part that is mechanically connected to the second structure; however, this configuration is problematic as it complicates the handling of the user interface when the cooking appliance is in “barbecue” mode.

### SUMMARY OF THE INVENTION

The technical problem behind the invention consists in particular of providing a cooking appliance that enables food products to be cooked in a grill configuration, but also in a barbecue configuration while being ergonomic and easy to use in the grill configuration as well as in the barbecue configuration and while optionally allowing for the collection of cooking juices from a front panel of the first structure.

To this end, the present invention relates to a cooking appliance for cooking food products, the cooking appliance comprising:
a first structure comprising a first cooking module comprising a first hotplate,
a second structure comprising a second cooking module comprising a second hotplate,
a pivot connector connecting the second structure to the first structure and configured to enable the second structure to rotate relative to the first structure around a pivot axis and between a closing position in which the first hotplate and the second hotplate are a minimum distance apart, and for example are in contact, and a maximum opening position in which the first hotplate and the second hotplate are a maximum distance apart when the cooking appliance is resting on a horizontal support surface,
a first user interface arranged on the first structure,
a control unit configured to control the operation of the cooking appliance,
   the cooking appliance having a first mode of use, called the grill mode, in which a food item is intended to be enclosed between the first and second hotplates, and a second mode of use, called the barbecue mode, in which each of the first and second hotplates can hold and cook a respective food item: in other words, in which each of the first and second hotplates is operational,
   characterized in that the cooking appliance comprises a second user interface arranged on the second structure, in that the first user interface is used for the first mode of use and the second user interface is used for the second mode of use, and in that the control unit is configured to activate the first user interface and deactivate the second user interface when the cooking appliance is in the first mode of use, and to activate the second user interface and deactivate the first user interface when the cooking appliance is in the second mode of use.

The presence of a second user interface provided on the second structure as well as of a first user interface provided on the first structure enable the user to interact in an easy and ergonomic way with the cooking appliance regardless of the position of the second structure. Also advantageously, the interdependence between the activation of the first user interface and the deactivation of the second user interface makes it possible to limit the potential risks of unwanted interaction with one or other of the user interfaces of the cooking appliance when handling it, for example.

The electric cooking appliance can also have one or more of the following characteristics, taken alone or in combination.

According to one embodiment of the invention, the second structure is in the maximum opening position when the cooking appliance is in the second mode of use.

According to one embodiment of the invention, the cooking appliance is configured such that the first hotplate and the second hotplate define a first angle of inclination comprised between 150 and 200°, advantageously between 170 and 190°, and for example approximately 180°, when the second structure is in the maximum opening position.

According to one embodiment of the invention, each of the first and second user interfaces is configured to enable a user to select at least one operating parameter of the cooking appliance.

According to one embodiment of the invention, the activation of the first user interface is conditional on the deactivation of the second user interface, and conversely, the activation of the second user interface is conditional on the deactivation of the first user interface.

According to one embodiment of the invention, the second user interface and the first user interface are specifically configured to enable a user to switch the cooking appliance on or off, set the temperature of the first and second cooking modules, and/or access automatic cooking programs.

According to one embodiment of the invention, the first cooking module and the second cooking module respectively comprise a first heating element and a second heating element.

According to one embodiment of the invention, the control unit is configured to activate the first user interface and deactivate the second user interface when a first activation condition is detected by the control unit, and to activate the second user interface and deactivate the first user interface when a second activation condition is detected by the control unit.

According to one embodiment of the invention, the first and second hotplates are substantially parallel when the second structure is in the maximum opening position.

According to one embodiment of the invention, the first user interface and the second user interface can feature different buttons or knobs or a touch screen for accessing a menu.

According to one embodiment of the invention, the cooking appliance is configured such that the first activation condition is reached when the second structure is rotated, from the maximum opening position towards the closing position and reaches a first predetermined position between the closing position and the maximum opening position, and such that the second activation condition is reached when the second structure is rotated, from the closing position towards the maximum opening position and reaches a second predetermined position between the closing position and the maximum opening position.

According to one embodiment of the invention, the first and second predetermined positions are identical.

According to one embodiment of the invention, the first and second predetermined positions are different from each other.

According to one embodiment of the invention, the second structure can be in an intermediate opening position that is stable and is between the closing position and the maximum opening position.

According to one embodiment of the invention, the cooking appliance is configured such that the first hotplate and the second hotplate define a second angle of inclination comprised between 90 and 120° when the second structure is in the intermediate opening position.

According to one embodiment of the invention, when the cooking appliance is in the first mode of use, the second structure is in a position between the closing position and the intermediate opening position.

According to one embodiment of the invention, the first and second predetermined positions correspond, for example, to the same position near, and for example immediately after, the intermediate opening position, or near the maximum opening position.

According to one embodiment of the invention, the second structure comprises at least one linking arm connected to the pivot connector, and for example two lateral linking arms each connected to the pivot connector. Advantageously, the gripping handle comprises the two lateral linking arms.

According to one embodiment of the invention, the cooking appliance comprises at least one additional pivot connector that is configured to connect the second cooking module to the at least one linking arm and to allow the second cooking module to rotate relative to the at least one linking arm around an additional pivot axis. Advantageously, the at least one additional pivot connector enables the second cooking module to be positioned in the desired orientation, and in general substantially parallel to the first cooking module, without being influenced by the relative spacing of the first and second cooking modules, and more particularly the first and second hotplates.

According to one embodiment of the invention, the additional pivot axis is substantially parallel to the pivot axis.

According to one embodiment of the invention, the pivot axis is substantially horizontal when the cooking appliance is resting on a horizontal surface.

According to one embodiment of the invention, the cooking appliance further comprises an electrical contact configured to be in a first state when the cooking appliance is in the first mode of use, and for example when the second structure is in a position between the closing position and the intermediate opening position, and configured to be in a second state when the cooking appliance is in the second mode of use, and for example when the second structure is in a position between the intermediate opening position and the maximum opening position.

According to one embodiment of the invention, the electrical contact is configured to be in the first state as long as the second structure is in a position between the closing position and the intermediate opening position, and to be in the second state as long as the second structure is in a position between the intermediate opening position and the maximum opening position, excluding the intermediate opening position.

According to one embodiment of the invention, the electrical contact is an on/off sensor, for example: a switch, a toggle switch, a push button or a microswitch.

According to the first embodiment of the invention, the electrical contact is configured to be moved to the second state when the second structure is rotated, from the intermediate opening position, towards the maximum opening position and reaches the second predetermined position, and to be moved to the first state when the second structure is rotated, from a position between the maximum opening position and the intermediate opening position, towards the intermediate opening position and reaches the first predetermined position.

According to one embodiment of the invention, the cooking appliance comprises an actuating device configured to move the electrical contact to the first state when the second structure is rotated, from the maximum opening position, towards the closing position, and reaches the first predetermined position, and to move the electrical contact to the second state when the second structure is rotated, from the closing position, towards the intermediate opening position and reaches the second predetermined position.

According to one embodiment of the invention, the actuating device comprises an actuating member, such as an actuating pin, that is pivotally attached to the second structure and that is configured to activate or deactivate the electrical contact when the second structure reaches the first predetermined position and to deactivate or activate the electrical contact when the second structure reaches the second predetermined position. According to such an embodiment, the electrical contact can, for example, be attached to the first structure and be static.

According to one embodiment of the invention, the actuating device comprises an actuating member that can be moved, for example in translation, between an actuating position in which the actuating member is configured to activate the electrical contact and a resting position in which the actuating member is configured to deactivate the electrical contact, and a cam configured to move the actuating member from the resting position to the actuating position when the second structure reaches the first predetermined position or the second predetermined position.

According to one embodiment of the invention, the actuating device is provided at least partially inside one of the lateral linking arms. This arrangement reduces the size of the cooking appliance.

According to one embodiment of the invention, the cam is pivotally attached to the second structure.

According to another embodiment of the invention, the cam is immobile relative to the first structure.

According to one embodiment of the invention, the actuating member is mounted on the second structure and is therefore rotatably mounted around the pivot axis.

According to one embodiment of the invention, the actuating member has a first actuating portion configured to interact with the cam and a second actuating portion configured to interact with the electrical contact, and more specifically to activate and deactivate the electrical contact.

According to one embodiment of the invention, the actuating device also comprises a biasing member, such as a return spring for example, configured to bias the actuating member towards the resting position when the cam is angularly offset relative to the actuating member.

According to one embodiment of the invention, the gripping handle is configured to be positioned on the side of a front panel of the first structure when the second structure is in the closing position.

According to one embodiment of the invention, the second user interface is provided on the gripping handle, and for example on the gripping part.

According to one embodiment of the invention, the first user interface is provided on a side panel of the first structure.

According to one embodiment of the invention, the cooking appliance comprises a locking device that can be moved between a locking state in which the rotation amplitude of the second structure is restricted to rotating between the closing position and the intermediate opening position, and an unlocking state in which the second structure can be moved up to the maximum opening position.

According to one embodiment of the invention, the locking device comprises a handling part and a locking part that are mechanically connected, the handling part being movably mounted, for example translationally, between a first position and a second position; the locking device is configured such that moving the handling part from the first position to the second position causes the locking part to move into a locking position corresponding to the locking state of the locking device, and such that moving the handling part from the second position to the first position causes the locking part to move to an unlocking position corresponding to the unlocking state of the locking device.

According to one embodiment of the invention, the locking device comprises an electrical contact configured to be in a first state, and for example to be deactivated or activated, when the locking part is in the locking position, and configured to be in a second state, and for example to be activated or deactivated when the locking part is in the unlocking position.

According to one embodiment of the invention, the locking part is configured to be kept in the unlocking position as long as the second structure is in a position between the intermediate opening position and the maximum opening position, excluding the intermediate opening position.

According to one embodiment of the invention, the cooking appliance is configured such that the first activation condition is reached when the locking part is moved to the unlocking position, and such that the second activation condition is reached when the locking part is moved to the locking position.

According to one embodiment of the invention, the locking part is automatically moved to the unlocking position when the second structure is rotated, from a position between the maximum opening position and the intermediate opening position, towards the intermediate opening position and reaches the intermediate opening position.

According to one embodiment of the invention, the handling part is provided on at least one linking arm of the second structure.

According to one embodiment of the invention, the actuating device is formed at least in part by the locking device.

According to one embodiment of the invention, the second structure comprises a gripping handle configured to be handled by a user, the second user interface being provided on the gripping handle.

According to one embodiment of the invention, when the first structure is resting on a horizontal surface and the second structure is in the maximum opening position, the gripping handle is in contact with said horizontal surface.

According to one embodiment of the invention, the gripping handle is configured to support the second cooking module.

According to one embodiment of the invention, the first hotplate is configured to be tilted downwards and towards a front panel of the first structure when the cooking appliance is resting on a horizontal surface.

According to one embodiment of the invention, the second hotplate is configured to be tilted downwards and towards the front panel of the first structure when the cooking appliance is resting on a horizontal surface and when the second structure is in the maximum opening position.

According to one embodiment of the invention, the cooking appliance further comprises a cooking juice collection tray configured to collect cooking juices from at least the first hotplate, the cooking juice collection tray being arranged at least in part under the first cooking module.

According to one embodiment of the invention, the first hotplate comprises a front outflow portion that is provided on a front edge of the first hotplate and that is located directly above a front portion of the cooking juice collection tray, the front outflow portion being configured to allow the cooking juices from the first hotplate to flow by gravity into the cooking juice collection tray. Such a configuration of the first hotplate, combined with a downward and forward tilt of the first hotplate, makes it possible to generate a flow of the cooking juices on the first hotplate towards the cooking juice collection tray when the cooking appliance is resting on a substantially horizontal support surface. These features limit smoke emissions and ensure that the scalding steam is released at the rear of the cooking appliance, away from the user.

According to one embodiment of the invention, the second hotplate comprises an additional outflow part that is provided on a transverse edge of the second hotplate and that is configured to be located directly above a rear portion of the cooking juice collection tray when the second structure is in the maximally open position; the additional outflow part is configured to allow the cooking juices from the second hotplate to flow by gravity into the cooking juice collection tray when the second structure is in the maximally open position. Such a configuration of the second hotplate, combined with a downward and forward tilt of the second hotplate when the second structure is in the maximum opening position, makes it possible to generate a flow of the cooking juices on the second hotplate towards the cooking juice collection tray when the cooking appliance is resting on a substantially horizontal support surface and is used as a barbecue.

According to one embodiment of the invention, the cooking juice collection tray is removable.

According to one embodiment of the invention, the cooking appliance comprises a position detection device configured to detect the modes of use, the position detection device being an angular sensor such as a potentiometer, for example.

### BRIEF DESCRIPTION OF THE FIGURES

The present invention will be clearly understood from the following description with reference to the appended figures, in which identical reference signs correspond to structurally and/or functionally identical or similar elements.

FIG. 1 is a perspective side view of a cooking appliance according to a first embodiment of the invention in grill configuration;

FIG. 2 is a perspective side view of the cooking appliance in FIG. 1 in barbecue configuration;

FIG. 3 is a longitudinal cross-section view of the cooking appliance in FIG. 1 in a closing position;

FIG. 4 is a partial longitudinal cross-section view of the cooking appliance in FIG. 1 in a maximum opening position;

FIG. 5 is a schematic side view of a cooking appliance according to a second embodiment of the invention and in a closing position;

FIG. 6 is a schematic side view of the cooking appliance in FIG. 5 in the maximum opening position;

FIG. 7 is a schematic side view of a cooking appliance according to a third embodiment of the invention and in the closing position;

FIG. 8 is a schematic side view of the cooking appliance in FIG. 7 in the maximum opening position.

### DETAILED DESCRIPTION

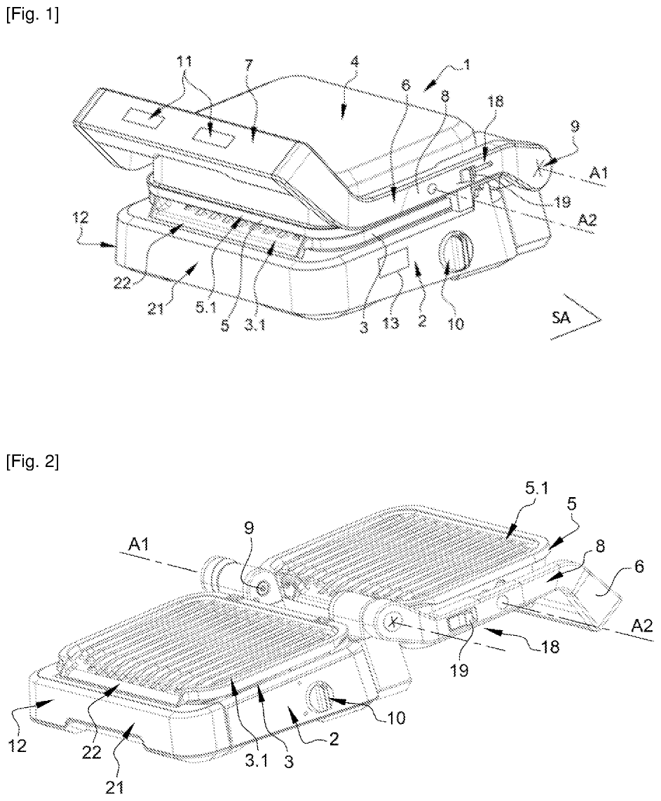

FIGS. 1 to 4 show a cooking appliance 1 according to a first embodiment of the invention. The cooking appliance 1 is configured for cooking food, such as meat, fish, vegetables or other food products.

The cooking appliance 1 comprises a first structure 2 that comprises a first cooking module 3 which itself comprises a first hotplate 3.1 and a first heating element (not visible in the figures) configured to heat the first hotplate 3.1, and a second structure 4 that comprises a second cooking module 5, which itself comprises a second hotplate 5.1 and a second heating element (not visible in the figures) configured to heat the second hotplate 5.1.

The cooking appliance 1 has a first mode of use, called the grill mode, in which a food item is intended to be enclosed and cooked between the first and second hotplates 3.1, 5.1, and a second mode of use, called the barbecue mode, in which each of the first and second hotplates 3.1, 5.1 can hold and cook a respective food item, in other words, in which each of the first and second hotplates 3.1, 5.1 is operational. The second structure 4 also comprises a gripping handle 6 comprising a gripping part 7 configured to be handled by a user, as well as two lateral linking arms 8. The gripping handle 6 is advantageously configured to support the second cooking module 5 and is U-shaped.

The second structure 4 is connected to the first structure 2 by a pivot connector 9 which defines a pivot axis A1. The pivot connector 9 is configured such that the second structure 4 is hinged to the first structure 2 and can be moved between a closing position in which the first hotplate 3.1 and the second hotplate 5.1 are a minimum distance apart, and for example are in contact, and a maximum opening position in which the first hotplate 3.1 and the second hotplate 5.1 are a maximum distance apart and define a first angle of inclination comprised between 150 and 200°, and advantageously between 170 and 190°.

Advantageously, the second structure 4 is configured to be in:
an intermediate opening position that is stable and is between the closing position and the maximum opening position and in which the first hotplate 3.1 and the second hotplate 5.1 define a second angle of inclination comprised between 90 and 120°, and
a plurality of cooking positions between the closing position and the intermediate opening position and in each of which food can be enclosed between the first hotplate 3.1 and the second hotplate 5.1.

Advantageously, the first and second hotplates 3.1, 5.1 are substantially parallel when the second structure 4 is in the maximum opening position, in order to offer the user a cooking appliance 1 that can be used like an electric barbecue.

For obvious practical reasons, the first structure 2 comprises legs configured to rest on a flat support surface SA, such as a worktop.

According to the first embodiment of the invention, the second structure 4 comprises an additional pivot connector 24 that is configured to connect the second cooking module 5 to the lateral linking arms 8 and to allow the second cooking module 5 to rotate relative to the lateral linking arms 8 around an additional pivot axis A2 that is substantially parallel to the pivoting axis A1. Advantageously, the additional pivot connector 24 enables the second cooking module 5 to be positioned in the desired orientation, and in general substantially parallel to the first cooking module 3 when the second structure 4 is in one of the cooking positions. In other words, the second cooking module 5 is pivotally mounted relative to the gripping handle 6. Advantageously, the gripping part 7 of the gripping handle 6 is configured to be in contact with the support surface SA when the second structure 4 is in the maximum opening position.

According to the first embodiment of the invention as shown in FIGS. 1 to 4, the cooking appliance 1 also comprises a first user interface 10 that is provided on the first structure 2 and that is configured to enable a user to select at least one operating parameter of the cooking appliance 1. Advantageously, the first user interface 10 is provided on a side panel of the first structure 2.

The cooking appliance 1 also comprises a second user interface 11 that is provided on the second structure 4 and that is also configured to enable a user to select at least one operating parameter of the cooking appliance 1. Advantageously, the second user interface 11 is provided on the gripping part 7 in order to facilitate access by the user when the second structure 4 is in one of the cooking positions or in the closing position.

Advantageously, the first user interface 10 is used for the first mode of use and the second user interface 11 is used for the second mode of use.

The first user interface 10 and the second user interface 11 can feature different buttons or knobs or even a touch screen for accessing a menu. The second user interface 11 and the first user interface 10 are specifically configured to enable a user to switch the cooking appliance 1 on or off, set the temperature of the first and second cooking modules 3, 5, or even access automatic cooking programs.

The cooking appliance 1 also comprises a control unit 13 configured to control the operation of the cooking appliance 1. Advantageously, the control unit 13 is configured to activate the first user interface 10 and deactivate the second user interface 11 when the cooking appliance 1 is in the first mode of use, and to activate the second user interface 11 and deactivate the first user interface 10 when the cooking appliance 1 is in the second mode of use.

The control unit 13 is more particularly configured to activate the first user interface 10 and deactivate the second user interface 11 when a first activation condition is detected by the control unit 13, and to activate the second user interface 11 and deactivate the first user interface 10 when a second activation condition is detected by the control unit 13. The first and second activation conditions are defined such that the first user interface 10 and the second user interface 11 are respectively activated and deactivated when the cooking appliance 1 is in the first mode of use, and such that the first user interface 10 and the second user interface 11 are respectively deactivated and activated when the cooking appliance 1 is in the second mode of use.

Moreover, the cooking appliance 1 is configured such that the first activation condition is reached when the second structure 4 is rotated, from the maximum opening position, towards the intermediate opening position and reaches a first predetermined position between the intermediate opening position and the maximum opening position, and such that the second activation condition is reached when the second structure 4 is rotated, from the intermediate opening position towards the maximum opening position and reaches a second predetermined position between the intermediate opening position and the maximum opening position.

According to the first embodiment of the invention, the first and second predetermined positions are adjacent to and near the maximum opening position. For example, the second predetermined position could be the maximum opening position, such that the second activation condition would be detected by the control unit 13 only when the second structure 4 reaches the maximum opening position and the first predetermined position could be immediately before the maximum opening position, such that the first activation condition would be detected by the control unit 13 as soon as the second structure 4 leaves the maximum opening position. According to a variant embodiment of the invention, it could be foreseen that the first and second predetermined positions are spaced apart or are located near the intermediate opening position.

Advantageously, the presence of a second user interface 11 provided on the second structure 4, and more particularly on the gripping part 7 of the gripping handle 6, as well as of a first user interface 10 provided on the first structure 2 enable the user to interact in an easy and ergonomic way with the cooking appliance 1 regardless of the position of the second structure 4. Also advantageously, the interdependence between the activation of the first user interface 10 and the deactivation of the second user interface 11 makes it possible to limit the potential risks of unwanted interaction with one or other of the user interfaces of the cooking appliance 1 when handling it, for example.

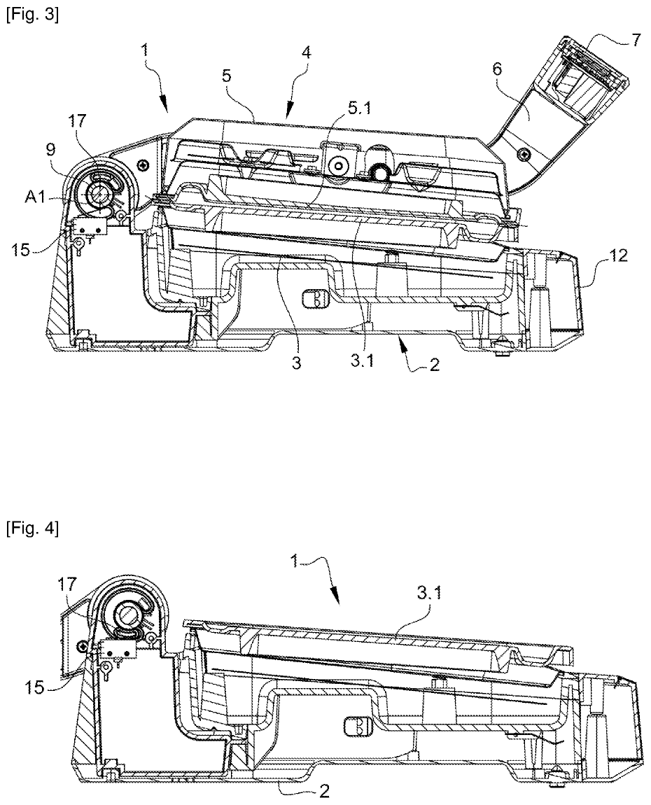

As can be seen more specifically in FIGS. 3 and 4, the cooking appliance 1 also has an electrical contact 15, such as a microswitch, configured to be in a first state, and for example to be deactivated or activated, when the cooking appliance 1 is in the first mode of use, and configured to be in a second state, and for example to be activated or deactivated, when the cooking appliance 1 is in the second mode of use.

According to the first embodiment of the invention, the electrical contact 15 is configured to be moved to the second state when the second structure 4 is rotated, from the intermediate opening position, towards the maximum opening position and reaches the second predetermined position, and to be moved to the first state when the second structure 4 is rotated, from a position between the maximum opening position and the intermediate opening position, towards the intermediate opening position and reaches the first predetermined position.

Advantageously, the electrical contact 15 is configured to be in the first state at least when the second structure 4 is in a position between the closing position and the intermediate opening position, and to be in the second state at least when the second structure 4 is in the maximum opening position. According to a variant embodiment of the invention, the electrical contact 15 could be configured to be in the first state as long as the second structure 4 is in a position between the closing position and the intermediate opening position, and to be in the second state as long as the second structure 4 is in a position between the intermediate opening position and the maximum opening position, excluding the intermediate opening position.

According to the first embodiment of the invention, the electrical contact 15 is static and is arranged in the first structure 2, and for example near the pivot connector 9.

The cooking appliance 1 also comprises an actuating device configured to move the electrical contact 15 to the first state when the second structure 4 is rotated, from the maximum opening position, towards the closing position and reaches the first predetermined position, and to move the electrical contact 15 to the second state when the second structure 4 is rotated, from the closing position, towards the maximum opening position and reaches the second predetermined position.

According to the first embodiment of the invention, the actuating device comprises an actuating member 17, such as an actuating pin, that is pivotally attached to the second structure 4 and that is configured to activate the electrical contact 15 when the second structure 4 substantially reaches the maximum opening position and to deactivate the electrical contact 15 when the second structure 4 moves slightly away from the maximum opening position.

Advantageously, the cooking appliance 1 comprises a locking device 18 that can be moved between a locking state in which the rotation amplitude of the second structure 4 is restricted to rotating between the closing position and the intermediate opening position, and an unlocking state in which the second structure 4 can be moved up to the maximum opening position, and can therefore be moved between the closing position and the maximum opening position. Advantageously, the locking state of the locking device 18 makes it possible to keep the second structure 4 in a stable position when it is in the intermediate opening position.

According to the first embodiment of the invention, the locking device 18 comprises a locking part that is mechanically connected to a handling part 19 that is provided on one of the lateral linking arms 8 of the gripping handle, so as to be accessible by the user. The handling part 19 can be moved in translation between a first position and a second position. The locking device 18 is configured such that moving the handling part 19 from the first position to the second position causes the locking part to move to a locking position corresponding to the locking state of the locking device 18, and such that moving the handling part 19 from the second position to the first position causes the locking part to move to an unlocking position corresponding to the unlocking state of the locking device 18. Advantageously, the cooking appliance 1 is configured such that the handling part 19 is kept in the first position when the second structure 4 is moved between the intermediate opening position and the maximum opening position.

Also, according to the first embodiment of the invention, the cooking appliance 1 further comprises a cooking juice collection tray 21 that is configured to collect cooking juices from the first and second cooking modules 3, 5. The cooking juice collection tray 21 is arranged under the first cooking module 3. The cooking juice collection tray 21 can, for example, be removable so that it can be emptied and cleaned.

According to the first embodiment of the invention, the first hotplate 3.1 comprises a front outflow part 22 that is provided on a front edge of the first hotplate 3.1 and that is located directly above a front part of the cooking juice collection tray 21. The front outflow part 22 is more specifically configured to allow the cooking juices from the first hotplate 3.1 to flow by gravity into the cooking juice collection tray 21.

Advantageously, the second hotplate 5.1 comprises an additional outflow part 23 that is provided on a transverse edge of the second hotplate 5.1 and that is configured to be located directly above a rear part of the cooking juice collection tray 21 when the second structure 4 is in the maximum opening position. The additional outflow part 23 is configured to allow the cooking juices from the second hotplate 5.1 to flow by gravity into the cooking juice collection tray 21 when the second structure 4 is in the maximum opening position.

Advantageously, the first hotplate 3.1 is configured to be tilted downwards and towards a front panel 12 of the first structure 2 when the cooking appliance 1 is resting on a horizontal surface, and the second hotplate 5.1 is also configured to be tilted downwards and towards the front panel 12 of the first structure 2 when the cooking appliance 1 is resting on a horizontal surface and the second structure 4 is in the maximum opening position. Such a tilt of the first and second hotplates 3.1, 5.1 makes it possible to generate a flow of the cooking juices towards the cooking juice collection tray 21 when the cooking appliance 1 is resting on a substantially horizontal support surface SA.

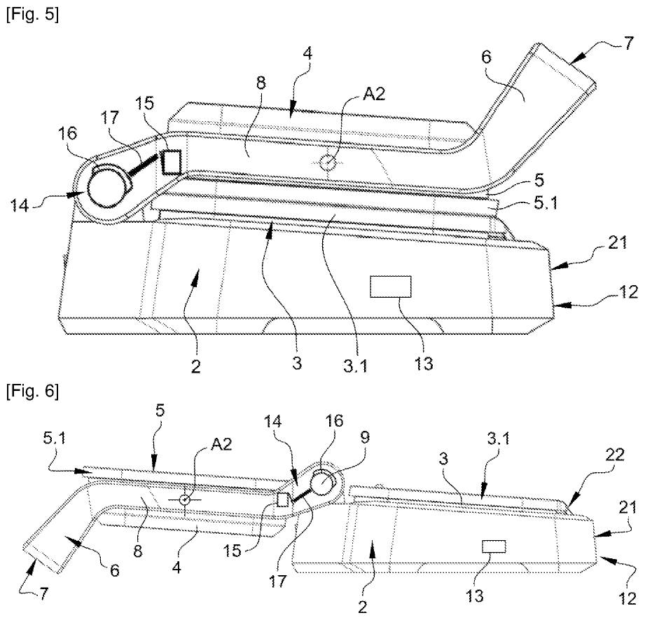

FIGS. 5 and 6 show a cooking appliance 1 that differs from the first embodiment shown in FIGS. 1 to 4 essentially in that the first and second predetermined positions are identical and located near the intermediate opening position, and, for example, immediately after the intermediate opening position towards the maximum opening position, and in that the actuating device comprises a cam 16 and an actuating member 17 that can be moved, for example in translation, between an actuating position in which the actuating member 17 is configured to activate the electrical contact 15 and a resting position in which the actuating member 17 is configured to deactivate the electrical contact 15. The cam 16 is more specifically configured to move the actuating member 17 from the resting position to the actuating position when the second structure 4 is rotated, from a position between the maximum opening position and the intermediate opening position, towards the intermediate opening position and substantially reaches the intermediate opening position.

Advantageously, the actuating device comprises a biasing member, (not shown in the figures), such as a return spring, configured to bias the actuating member 17 towards the resting position when the cam 16 is angularly offset relative to the actuating member 17.

According to the second embodiment of the invention, the cam 16 is immobile relative to the first structure 2 and comprises an arc-shaped cam surface that is coaxial with the pivot axis A1, and the actuating member 17 is mounted on the second structure 4 and is housed, for example, in one of the lateral linking arms 8. Advantageously, the electrical contact 15 is also housed in one of the lateral linking arms 8.

The actuating member 17 has a first actuating portion, for example formed by a first end of the actuating member 17, configured to cooperate with the cam 16, and a second actuating portion, for example formed by a second end of the actuating member 17, configured to cooperate with the electrical contact 15, and more particularly to activate and deactivate the electrical contact 15. Advantageously, when moving the second structure 4 between the closing position and the intermediate opening position, the cam 16 cooperates with the actuating member 17 and keeps it in its actuating position; conversely, when moving the second structure 4 between the intermediate opening position and the maximum opening position, the cam 16 releases the actuating member 17 and the latter is biased towards the resting position by the biasing member.

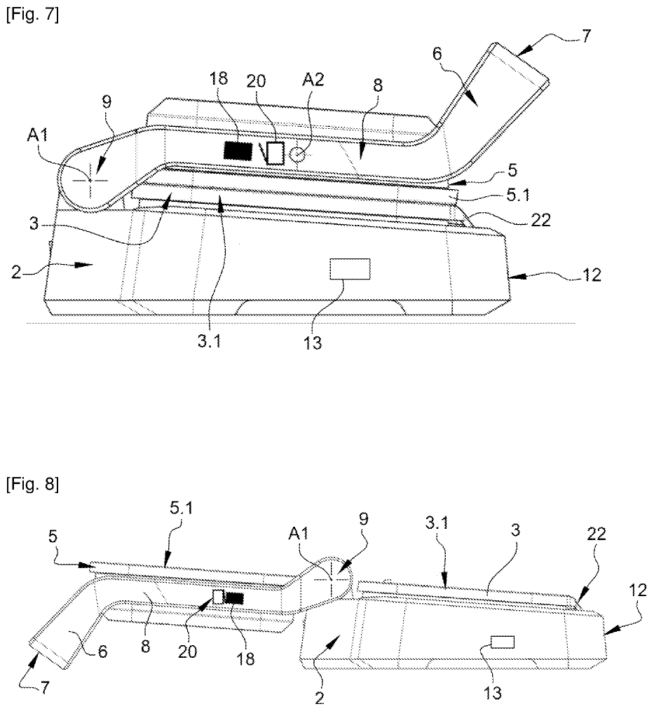

FIGS. 7 and 8 represent a cooking appliance 1 according to a third embodiment of the invention that differs from the second embodiment in particular, in that the locking device 18 also comprises an electrical contact 20, such as a microswitch, configured to be in a first state, and for example to be deactivated or activated, when the locking part is in the locking position, and configured to be in a second state, and for example to be activated or deactivated, when the locking part is in the unlocking position. Advantageously, the locking part is configured to be kept in the unlocking position as long as the second structure 4 is in a position between the intermediate opening position and the maximum opening position, excluding the intermediate opening position.

Thus, according to this third embodiment of the invention, the cooking appliance 1 is configured such that the first activation condition is reached when the locking part is moved to the unlocking position, that is, when the handling part 19 is moved to the first position and the electrical contact 20 is activated, and such that the second activation condition is reached when the locking part is moved to the locking position, that is, when the handling part 19 is moved to the second position and the electrical contact 20 is deactivated.

According to one embodiment of the invention not shown in the figures, the cooking appliance 1 could comprise a position detection device, such as a linear or rotary potentiometer for example, and the position detection device could be configured to control the first and second modes of use based on values from the position detection device.

Of course, the present invention is by no means limited to the embodiments described and illustrated, which have only been provided by way of example. Further changes are possible, particularly with regard to the composition of the various components or through the substitution of technical equivalents, without necessarily departing from the scope of protection of the invention.

1. A cooking appliance for cooking food products, the cooking appliance comprising:
a first structure comprising a first cooking module comprising a first hotplate,
a second structure comprising a second cooking module comprising a second hotplate,
a pivot connector connecting the second structure to the first structure and configured to enable the second structure to rotate relative to the first structure around a pivot axis and between a closing position in which the first hotplate and the second hotplate are a minimum distance apart, and a maximum opening position in which the first hotplate and the second hotplate are a maximum distance apart when the cooking appliance is resting on a horizontal support surface,
a first user interface arranged on the first structure, and
a control unit configured to control the operation of the cooking appliance,
the cooking appliance having a first mode of use, called the grill mode, in which a food item is intended to be enclosed between the first and second hotplates, and a second mode of use, called the barbecue mode, in which each of the first and second hotplates can hold and cook a respective food item,
wherein the cooking appliance comprises a second user interface arranged on the second structure,
wherein the first user interface is used for the first mode of use and the second user interface is used for the second mode of use, and
wherein the control unit is configured to activate the first user interface and deactivate the second user interface when the cooking appliance is in the first mode of use, and to activate the second user interface and deactivate the first user interface when the cooking appliance is in the second mode of use.

2. The cooking appliance according to claim 1, wherein the control unit is configured to activate the first user interface and deactivate the second user interface when a first activation condition is detected by the control unit, and to activate the second user interface and deactivate the first user interface when a second activation condition is detected by the control unit.

3. The cooking appliance according to claim 2, wherein the cooking appliance configured such that the first activation condition is reached when the second structure is rotated, from the maximum opening position towards the closing position and reaches a first predetermined position between the closing position and the maximum opening position, and such that the second activation condition is reached when the second structure is rotated, from the closing position towards the maximum opening position and reaches a second predetermined position between the closing position and the maximum opening position.

4. The cooking appliance according to claim 3, wherein the first and second predetermined positions are identical.

5. The cooking appliance according to claim 1, wherein the second structure is configured to be in an intermediate opening position that is stable and is between the closing position and the maximum opening position.

6. The cooking appliance according to claim 5, further comprising a locking device configured to be moved between a locking state in which the rotation amplitude of the second structure is restricted to rotating between the closing position and the intermediate opening position, and an unlocking state in which the second structure can be moved up to the maximum opening position.

7. The cooking appliance according to claim 6, wherein the locking device comprises a handling part and a locking part that are mechanically connected, the handling part being movably mounted between a first position and a second position; the locking device is configured such that moving the handling part from the first position to the second position causes the locking part to move into a locking position corresponding to the locking state of the locking device, and such that moving the handling part from the second position to the first position causes the locking part to move to an unlocking position corresponding to the unlocking state of the locking device.

8. The cooking appliance according to claim 1, further comprising an electrical contact configured to be in a first state when the cooking appliance is in the first mode of use, and configured to be in a second state when the cooking appliance is in the second mode of use.

9. The cooking appliance according to claim 8,
wherein the cooking appliance configured such that the first activation condition is reached when the second structure is rotated, from the maximum opening position towards the closing position and reaches a first predetermined position between the closing position and the maximum opening position, and such that the second activation condition is reached when the second structure is rotated, from the closing position towards the maximum opening position and reaches a second predetermined position between the closing position and the maximum opening position,
wherein the cooking appliance further comprises an actuating device configured to move the electrical contact to the first state when the second structure is rotated from the maximum opening position towards the closing position and reaches the first predetermined position, and to move the electrical contact to the second state when the second structure is rotated from the closing position towards the intermediate opening position and reaches the second predetermined position.

10. The cooking appliance according to claim 9, wherein the actuating device comprises:
an actuating member configured to be moved between an actuating position in which the actuating member is configured to activate the electrical contact and a resting position in which the actuating member is configured to deactivate the electrical contact, and
a cam configured to move the actuating member from the resting position to the actuating position when the second structure reaches the first predetermined position or the second predetermined position.

11. The cooking appliance according to claim 9, further comprising a locking device configured to be moved between a locking state in which the rotation amplitude of the second structure is restricted to rotating between the closing position and the intermediate opening position, and an unlocking state in which the second structure can be moved up to the maximum opening position,
wherein the actuating device is formed at least in part by the locking device.

12. The cooking appliance according to claim 1, wherein the second structure comprises a gripping handle configured to be handled by a user, the second user interface being provided on the gripping handle.

13. The cooking appliance according to claim 12, wherein, when the first structure is resting on a horizontal surface and the second structure is in the maximum opening position, the gripping handle is in contact with said horizontal surface.

14. The cooking appliance according to claim 1, wherein the first hotplate is configured to be tilted downwards and towards a front panel of the first structure when the hotplate is resting on a horizontal surface.

15. The cooking appliance according to claim 1, further comprising a cooking juice collection tray configured to collect cooking juices from at least the first hotplate, the cooking juice collection tray being arranged at least in part under the first cooking module.

16. The cooking appliance according to claim 15, wherein the first hotplate comprises a front outflow part provided on a front edge of the first hotplate and located directly above a front part of the cooking juice collection tray, the front outflow part being configured to allow the cooking juices from the first hotplate to flow by gravity into the cooking juice collection tray.

17. The cooking appliance according to claim 1, wherein the first user interface is arranged on a side panel of the first structure.
